(19) United States
(12) Patent Application Publication
(10) Pub. No.: US 2024/0368438 A1
(43) Pub. Date: Nov. 7, 2024

(54) HPMC COMPOSITION FOR PROVIDING A HEAT-SEALABLE COATING ON PAPER AND BOARD

(71) Applicant: NUTRITION & BIOSCIENCES USA 1, LLC, Rochester, NY (US)

(72) Inventor: ROLAND BAYER, WALSRODE (DE)

(21) Appl. No.: 18/292,984

(22) PCT Filed: Jul. 13, 2022
(86) PCT No.: PCT/EP2022/069575

§ 371 Date: Jan. 29, 2024

(30) Foreign Application Priority Data
Jul. 28, 2021 (EP) 21188156.0

(51) Int. Cl. C09J 101/28; C08K 5/053; C08K 5/101; C09J 11/06; D21H 11/14; D21H 19/12; D21H 27/10

(52) U.S. Cl. CPC C09J 101/284; C09J 11/06; D21H 11/14; D21H 19/12; D21H 27/10; C08K 5/053; C08K 5/101

(57) ABSTRACT

The present invention relates to an aqueous solution for forming a heat-sealable coating on a paper or board surface for reducing MOSH or MOAH migration, said aqueous solution comprising a thermoplastic hydroxypropyl methylcellulose (HPMC) in an amount of from 10% to 60% (w/w), wherein said HPMC has a DS(methyl) of at least 1.0 and an MS(hydroxypropyl) of at least 0.6, wherein DS is the average number of hydroxyl groups substituted by methoxyl groups per anhydroglucose unit and MS is the average number of moles of hydroxyalkoxy groups per anhydroglucose units, and wherein the viscosity of said HPMC is from 2 mPa·s to 100 mPa·s, determined as a 2% (w/w) solution in water at 20° C. according to Ubbelohde.

### FIELD

The present invention relates to an aqueous solution of hydroxypropyl methylcellulose (HPMC) for formation of a heat-sealable coating of paper or board to reduce the migration or diffusion of Mineral Oil Hydrocarbons (MOH), more specifically Mineral Oil Saturated Hydrocarbons and Mineral Oil Aromatic Hydrocarbons (MOSH and MOAH) from the heat-sealed portions of coated paper or board into for example food.

### INTRODUCTION

Paper and board is frequently used for packaging purposes, such as for packaging of foodstuff or medical products. The packaged material (contained products) may have direct contact to the paper or board or the products may be packaged in a plastic container, which may be positioned in paper or board container. Frequently this paper or board is produced from recycled paper or recycled board. It is generally known that recycled paper and board contain Mineral Oil Hydrocarbons (MOH), i.e. Mineral Oil Saturated Hydrocarbons (MOSH) and Mineral Oil Aromatic Hydrocarbons (MOAH) from printing inks, lacquers and other former uses and processes. The aliphatic and aromatic hydrocarbonic substances in the recycled paper or board may therefore contaminate the contained products, for example food, by migration upon direct contact of the paper or board with the foodstuff, or the mineral oil hydrocarbons may diffuse via the gas phase through plastic containers into the foodstuff. Furthermore, paper or board packaging materials are often printed on one side. In addition to pigments or dyes, the print colors may contain oily substances such as MOSH and MOAH, and the oily substances may migrate into or through the paper or board packaging material. In analogy with above, the oily substances from the prints may subsequently contaminate the contained products, for example foodstuff or medical products, via migration upon direct contact or via diffusion through gas phase.

Particularly MOAH substances are under suspicion for having carcinogenic, mutagenic or other undesired effects on the human body, and therefore contamination of packaged material with MOH is undesirable. Furthermore, the contaminants may influence the taste or odor of the packaged material in a negative manner. It is known in the art that a functional barrier between the packaging material and the contained products can reduce or prevent the contamination of the contained products with MOSH or MOAH from the packaging material and it is expected that EU regulation will be passed which will impose a requirement of a functional barrier between recycled paper/board and foodstuff. [European Food Safety Authority; Scientific Opinion on Mineral Oil in Food; EFSA Journal 2012; 10(6):2704]

EVOH (ethylene-vinylalcohol-copolymers) has been described as a functional barrier against MOSH and MOAH as well as barriers against BTEX (benzene, toluene, ethylbenzene, xylene isomers) [Maes, C. et al., Polymer Reviews, 2018, 58 (2), 209-246]. However, EVOH is not made from renewable ressources and the polymer is not biodegradable; and therefore use of EVOH potentially leads to pollution of the environment with nanoplastics.

U.S. Pat. No. 9,051,115 describe a cardboard or paper interspersed with a filter material, such as activated charcoal, that absorbs mineral oil substances (MOSH/MOAH). However, the interspersed cardboard or paper requires a complex, and therefore costly, manufacturing process with the preparation of several layers on top of each other.

Alginate and chitosan has been tested as a functional barrier for paper-based packaging materials or [Kopacic, S; Coatings (2018), 8, 235]. However, the disclosed solution for coating are highly dilute (4% solid content) which is unsuitable for coating of packaging material on an industrial scale due to the large amounts of water to be evaporated, requiring high and costly energy consumption. Furthermore, the coating thickness of the applied alginate and chitosan coatings would only be 1.6 μm in the dry state (4% solid content in 40 μm wet film thickness).

US2014/0255629 disclose a dispersion for a barrier coating comprising at least 50% of a polyvinyl acetate copolymer in combination with a second polymer, for example a cellulose derivative. The barrier coating is intended for application on cardboard or paper to decrease the migration of oily substances such as MOSH or MOAH. Polyvinylacetate however is a fully synthetic polymer, i.e. it is not prepared from renewable ressources

PCT/US2021/014992 discloses an aqueous hydroxypropyl methylcellulose (HPMC) solution which when applied as a coating on paper or board surprisingly prevents or reduces MOH (MOSH and MOAH) migration from paper or board into a packaged material, such as a food product.

### SUMMARY

When paper or board based on recycled materials is intended for use a packaging for a food product, it must be cut into pieces of a suitable size to make paper bags and boxes which later on will contain and protect the food product. If the paper or board is coated, mineral oil hydrocarbons in the paper or board cannot diffuse into the food through the coating, but they can spoil the food product by diffusing out of cut edges and corners which are typically not covered with the coating. It has surprisingly been possible to identify a thermoplastic HPMC which a) can be used for a coating on paper or board by application of an aqueous solution (as described in PCT/US2021/014992) and b) can be used for a heat-sealing process. By contrast conventional HPMC is not thermoplastic and cannot be used in a heat-sealing process.

Accordingly, the present invention relates to an aqueous solution for forming a heat-sealable coating on a paper or board surface for reducing MOSH or MOAH migration, said aqueous solution comprising a thermoplastic hydroxypropyl methylcellulose (HPMC) in an amount of from 10% to 60% (w/w), wherein said HPMC has a DS(methyl) of at least 1.0 and an MS(hydroxypropyl) of at least 0.6, wherein DS is the average number of hydroxyl groups substituted by methoxyl groups per anhydroglucose unit and MS is the average number of moles of hydroxyalkoxy groups per anhydroglucose units, and wherein the viscosity of said hydroxypropyl methylcellulose (HPMC) is from 2 mPa·s to 100 mPa·s, determined as a 2% (w/w) solution in water at 20° C. according to Ubbelohde.

In another embodiment, the invention relates to a coating composition for forming a heat-sealable coating on a paper or board surface, said coating composition comprising an aqueous solution comprising a thermoplastic hydroxypropyl methylcellulose (HPMC) in an amount of from 10% to 60% (w/w), wherein said HPMC has a DS(methyl) of at least 1.0 and an MS(hydroxypropyl) of at least 0.6, wherein DS is the average number of hydroxyl groups substituted by methoxyl groups per anhydroglucose unit and MS is the average number of moles of hydroxyalkoxy groups per anhydroglucose units, and wherein the viscosity of said hydroxypropyl methylcellulose (HPMC) is from 2 mPa·s to 100 mPa·s.

In yet another embodiment the invention relates to the use of the coating composition according to the embodiment above for forming a heat-sealable coating on a paper or board surface for reducing MOSH or MOAH migration from one or more edges or corners of said surface.

In yet another embodiment the invention relates to a paper or board surface comprising the heat-sealable coating composition according to the embodiment above, at least a portion of said surface being subjected to heat-sealing.

In another embodiment, the invention relates to a method for heat-sealing at least a portion of a paper or board surface coated with the heat-sealable coating compostition according to the embodiment above, the method comprising
a. applying said coating composition on said paper or board surface,
b. drying the coating applied on said surface, and
c. heat-sealing at least a portion of said surface.

### BRIEF DESCRIPTION OF THE DRAWINGS

FIG. 1 is a schematic drawing showing the sealing of two aligned edges of a sheet of paper coated on the inside with the coating composition of the invention. The outer line is intended to denote a sheet of paper while the inner line is intended to denote the heat-sealable HPMC coating thereon. The joined portion is intended to show the edges of the coated paper that are heat-sealed together.

FIG. 2 shows the result of a heat-sealing trial of a sheet of paper after coating on the inner surface with a coating composition of Example 2 (the glossy surface at the top of the picture shows the coating): the heat-sealed edges of the sheet adhere to one another.

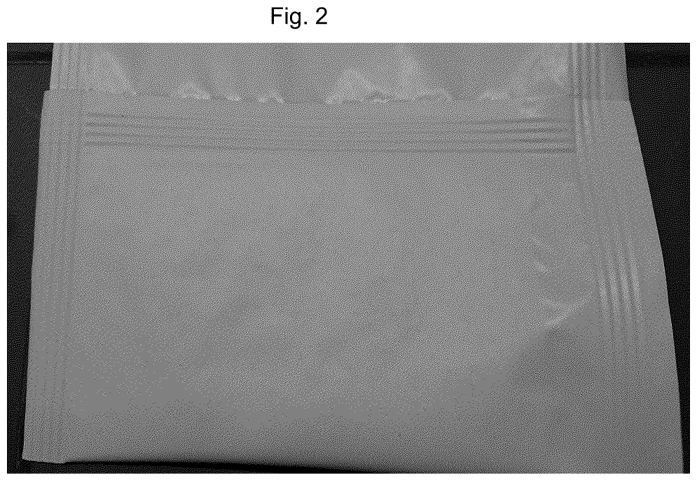

### DEFINITIONS

In the present context, mineral oil hydrocarbons (MOH) or mineral oil products are hydrocarbons containing 6 to about 50 carbon atoms. MOH consist of three major classes of compounds: paraffins (comprising linear and branched alkanes), naphthenes (comprising alkyl-substituted cyclo-alkanes), and aromatics (including polyaromatic hydrocarbons (PAHs), which are generally alkyl-substituted and only contain minor amounts of non-alkylated PAHs). MOH may also include minor amounts of nitrogen- and sulphur containing compounds. Within these classes there are enormous numbers of individual components. [Ref.: European Food Safety Authority; Scientific Opinion on Mineral Oil in Food; EFSA Journal 2012; 10(6):2704] In the present context, MOH have been divided into two main types,
Mineral Oil Saturated Hydrocarbons (MOSH), comprising alkanes, both branched and unbranched (paraffins); and cycloalkanes, mainly cyclopentanes and cyclohexanes, alkylated and non-alkylated, mono-, di- and higher ring systems (naphthenes); and
Mineral Oil Aromatic Hydrocarbons (MOAH), comprising aromatics (mono-, di- and higher ring systems), including alkyl-substituted aromatics

In the present context, the terms ‘paper’ and/or ‘board’ is intended to include materials such as paper, board, carton, cardboard, corrugated paper, corrugated cardboard. Paper and board materials and articles are manufactured from cellulose-based natural fibres both bleached and unbleached, from both primary and recycled sources. Paper and board materials may comprise one or more layers of fibres. In addition, paper and board materials may contain man-made fibres (regenerated and/or synthetic cellulose), functional additives and other treatment agents, polymeric binders for organic and inorganic pigments and plastic films. Paper and board articles may contain, in addition, inks, varnishes, coatings, adhesives and plastic films used during the conversion process.

The term ‘Recycled paper and/or board’ indicates paper and/or board prepared from recycled cellulosic fibers.

The term ‘Primary cellulosic fibers’ indicates fresh cellulosic fibers from for example from hardwood or soft wood.

The term ‘Secondary cellulosic fibers’ indicates cellulos fibers made from recycled fibers.

### DETAILED DESCRIPTION

In an embodiment the invention relates to an aqueous solution for forming a heat-sealable coating on a paper or board surface for reducing MOSH or MOAH migration, said aqueous solution comprising a thermoplastic hydroxypropyl methylcellulose (HPMC) in an amount of from 10% to 60% (w/w), wherein said HPMC has a DS(methyl) of at least 1.0 and an MS(hydroxypropyl) of at least 0.6, wherein DS is the average number of hydroxyl groups substituted by methoxyl groups per anhydroglucose unit and MS is the average number of moles of hydroxyalkoxy groups per anhydroglucose units, and wherein the viscosity of said hydroxypropyl methylcellulose (HPMC) is from 2 mPa·s to 100 mPa·s, determined as a 2% (w/w) solution in water at 20° C. according to Ubbelohde; and wherein the viscosity of said aqueous solution is from 200 to 80,000 mPa·s determined at 20° C. according to Haake.

In an embodiment the invention relates to the aqueous solution according to any one of the above embodiments, comprising water in an amount of from 30-90% (w/w).

In an embodiment the invention relates to a paper or board surface comprising the heat-sealable coating composition according to the embodiment above, at least an edge or corner of said surface being subjected to heat-sealing.

In an embodiment the invention relates to paper or board surface comprising a layer of a heat-sealable coating composition comprising the aqueous solution according to any one of the above embodiments, wherein the the wet-film thickness of said layer is less than 200 μm.

In an embodiment the invention relates to a recycled paper or board surface or printed paper or board surface, comprising a heat-sealable coating composition according to the embodiments above.

Hydroxypropyl methylcellulose (HPMC) has a cellulose backbone having β-1,4 glycosidically bound D-glucopyranose repeating units, designated as anhydroglucose units in the context of this invention. At least a part of the hydroxyl groups of the anhydroglucose units are substituted by a combination of methoxyl and hydroxypropoxyl groups.

The average number of methoxyl groups per anhydroglucose unit is designated as the degree of substitution of methoxyl groups, DS. In the definition of DS, the term “hydroxyl groups substituted by methoxyl groups” is to be construed within the present invention to include not only methylated hydroxyl groups directly bound to the carbon atoms of the cellulose backbone, but also methylated hydroxyl groups of hydroxypropoxyl substituents bound to the cellulose backbone.

The degree of the substitution of hydroxyl groups of the anhydroglucose units by hydroxypropoxyl groups is expressed by the molar substitution of hydroxypropoxyl groups, the MS. The MS is the average number of moles of hydroxypropoxyl groups per anhydroglucose unit in the hydroxypropyl methylcellulose. It is to be understood that during the hydroxypropoxylation reaction the hydroxyl group of a hydroxypropoxyl group bound to the cellulose backbone can be further etherified by a methylation agent and/or a hydroxypropoxylation agent. Multiple subsequent hydroxypropoxylation reactions with respect to the same carbon atom position of an anhydroglucose unit yields a side chain, wherein multiple hydroxypropoxyl groups are covalently bound to each other by ether bonds, each side chain as a whole forming a hydroxypropoxyl substituent to the cellulose backbone. The term “hydroxypropoxyl groups” thus has to be interpreted in the context of the MS as referring to the hydroxypropoxyl groups as the constituting units of hydroxypropoxyl substituents, which either comprise a single hydroxypropoxyl group or a side chain as outlined above, wherein two or more hydroxypropoxyl units are covalently bound to each other by ether bonding. Within this definition it is not important whether the terminal hydroxyl group of a hydroxypropoxyl substituent is further methylated or not; both methylated and non-methylated hydroxypropoxyl substituents are included for the determination of MS.

Providing a heat-sealable coating on paper or board according to the present invention requires a hydroxypropyl methylcellulose which is thermoplastic, i.e. that softens and forms a compressible and adhesive layer when heated so that two heated and compressed portions (e.g. edges) of a coated paper or board surface adhere together permanently upon subsequent cooling. The thermoplastic hydroxypropyl methylcellulose utilized in the composition of the present invention preferably has a DS of from 1.0 to 2.7 and an MS of from 0.60 to 1.50. Preferably the hydroxypropyl methylcellulose has a DS of from 1.0 to 2.6, more preferably of from 1.1 to 2.5 and most preferably of from 1.6 to 2.4. Preferably the hydroxypropyl methylcellulose has an MS of from 0.60 to 1.40. Any preferred range for DS can be combined with any preferred range for MS. Most preferably the hydroxypropyl methylcellulose has a DS of from 1.6 to 2.4 and an MS of from 0.60 to 1.40.

This thermoplastic hydroxypropyl methylcellulose has been found to be particularly useful for heat-sealing two surfaces together. A thermoplastic HPMC that can be utilized in the present invention is described in U.S. Pat. No. 4,614,545 and WO 2014/014752.

The degree of substitution of methoxyl groups (DS) and the molar substitution of hydroxypropyl groups (MS) can be determined by Zeisel cleavage of the thermoplastic HPMC with hydrogen iodide and subsequent quantitative gas chromatographic analysis (G. Bartelmus and R. Ketterer, Z. Anal. Chem., 286 (1977) 161-190). The determination of the % methoxyl and % hydroxypropoxyl is carried out according to the United States Pharmacopeia (USP 35, “Hypromellose”, pages 3467-3469). The values obtained are % methoxyl and % hydroxypropoxyl. These are subsequently converted into degree of substitution (DS) for methyoxyl substituents and molar substitution (MS) for hydroxypropoxyl substituents. Residual amounts of salt have been taken into account in the conversion.

The thermoplastic HPMC comprised in the aqueous solution of the present invention preferably has a viscosity of from 2 to 100 mPa·s, more preferably from 2 to 60 mPa·s, in particular from 2 to 50 mPa·s, such as from 2 to 40 mPa·s, from 2 to 30 mPa·s, from 2 to 20 mPa·s, such as from 2.4 to 15 mPa·s, from 3 to 6 mPa·s, from 3 to 5 mPa·s or from 3 to 4 mPa·s, measured as a 2 weight-% aqueous solution at 20° C. according to Ubbelohde. Ubbelohde viscosity measurements are conducted according to DIN 51562-1:1999-01 (January 1999). For example, a 2.0% by weight solution of hydroxypropyl methylcellulose in water is prepared according to United States Pharmacopeia (USP 35, “Hypromellose”, followed by an Ubbelohde viscosity measurement according to DIN 51562-1:1999-01 (January 1999).

The aqueous solution according to any one of the embodiments above preferably has a viscosity of more than 200 mPa·s, preferably from 200 to 2000 mPa·s, more preferably from 200 to 1800 mPa·s, such as from 200 to 1500 mPa·s; from 200 to 12000 mPa·s; from 200 to 1000 mPa·s; from 200 to 500 mPa·s determined at 20° C. in a Haake RS600 rheometer with a cone and plate Geometry (CP-60/2°) at 20° C. and at a shear rate of 2.55 s⁻¹.

The aqueous solution for according to any one of the embodiments above may comprise the thermoplastic HPMC in an amount of from 10% to 60% (w/w) of the aqueous solution, such as in an amount of from 10% to 50% (w/w), such as from 20% to 50% (w/w), such as from 25% to 50% (w/w), such as from 30% to 50% (w/w), such as from 25% to 40% (w/w) of the aqueous solution.

The aqueous solution according to any one of the embodiments above may comprise water in an amount of from 30-90% (w/w) of the solution, such as from 40-80% (w/w), such as from 50-80% (w/w), such as from 40-75% (w/w), such as from 50-75% (w/w), such as from 60-75% (w/w) of the solution.

In an embodiment the invention relates to the aqueous solution according to any one of the embodiments above comprising a plasticizer. The plasticizer may be selected from the group consisting of propylene glycol, ethyl lactate, glycerol and glycerol derivatives. The aqueous solution may comprise a plasticizer in an amount of up to 40% (w/w), such as an amount of from 5 to 40 (w/w) % of the combined weight of the HPMC and plasticizer.

In an embodiment the invention relates to paper or board surface comprising a layer of a heat-sealable coating composition comprising the aqueous solution according to any one of the embodiments above, which coating composition layer has a weight when dried of from 3 g/m² to 100 g/m², preferably from 5 g/m² to 90 g/m², more preferably from 10 g/m² to 80 g/m², still more preferably from 20 g/m² to 70 g/m², most preferably from 30 g/m² to 60 g/m².

In an embodiment of the invention, the paper or board surface may be pre-coated with a layer of non-thermoplastic HPMC before being cut into sheets and coated with the heat-sealable coating composition of the invention and heat-sealed at least at a portion of said surface such as an edge or corner thereof.

In an embodiment the invention relates to a method for heat-sealing at least a portion of a paper or board surface coated with the heat-sealable coating compostition according to any one of the embodiments above, the method comprising
a. applying said coating composition on said paper or board surface,
b. drying the coating applied on said surface, and
c. heat-sealing at least a portion of said surface.

In step a. of the method, the coating composition is preferably applied with a doctor blade or by spraying, dispersion coating, curtain coating lamination or extrusion.

In step b. of the method, the coating is preferably dried at room temperature, at elevated temperatures, in an oven or with infrared or microwave heating.

In step c. of the method, the heat-sealing is preferably conducted at a temperature of 150-250° C. and a load of 100 g/cm²-100 kg/cm².

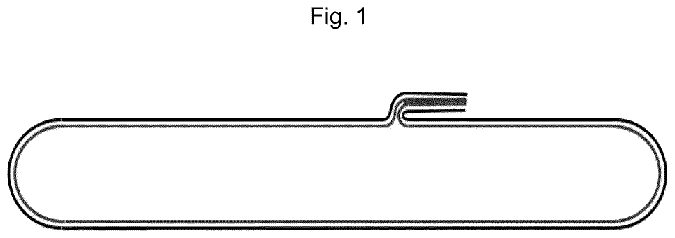

In a currently preferred embodiment of the method, at least two edges of said coated paper or board surface are brought into alignment with one another, e.g. by placing one coated sheet of paper or board on top of another coated sheet of paper or board, and heat-sealed together at the edges and/or corners thereof, for instance as shown in FIG. 1

The heat-sealed edge typically has a width of 0.5-2.0 cm, such as 1.0-1.5 cm.

### EXPERIMENTAL

AFFINISOL™ HME 15 (available from IFF) is a thermoplastic HPMC wherein the DS(methyl) is 1.6-2.3 and the MS(hydroxypropyl) is 0.8-1.1. The viscosity of a 2% aqueous solution of the HPMC is 12-18 mPa·s measured at 20° C. using an Ubbelohde viscometer. The tested batch had methoxyl substitution: 26.3%, hydroxylpropoxyl substitution: 27.4%

METHOCEL™ E3 LV (available from IFF), wherein the DS(methyl) is 1.84-2.03 and the MS(hydroxypropyl) is 0.28-0.34 and the nominal viscosity is 2.4-3.6 mPa·s, measured as 2% in water at 20° C., according to Ubbelohde; methoxyl substitution 28.0-30.0%; hydroxypropoxyl substitution 7.0-12.0%.

METHOCEL™ K3 LV, wherein the DS(methyl) is 1.16-1.57, the MS(hydroxypropyl) is 0.18-0.33 and the nominal viscosity is 2.4-3.6 mPa·s, measured as 2% in water at 20° C., according to Ubbelohde; methoxyl substitution 19.0-24.0%; hydroxypropoxyl substitution 7.0-12.0%. The tested batch had a viscosity of 3.1 mPa·s, a methoxyl substitution: 22.8%, hydroxylpropoxyl substitution: 0.23%

The plasticizers propylene glycol (PG) and ethyl lactate arecommercially available.

Ubbelohde viscosity measurements are conducted according to DIN 51562-1:1999-01 (January 1999). For example, a 2.0% by weight solution of hydroxypropyl methylcellulose in water is prepared according to United States Pharmacopeia (USP 35, “Hypromellose”, followed by an Ubbelohde viscosity measurement according to DIN 51562-1:1999-01 (January 1999).

Haake viscosity measuremetns are conducted at 20° C. in a Haake RS600 rheometer with a cone and plate Geometry (CP-60/2°) at 20° C. and at a shear rate of 2.55 s⁻¹

In this context the wet-film thickness of the applied coating or film is defined as slit-width of the doctor blade which was used for application of the film onto paper or board.

### Examples

### Procedure for Preparing an Aqueous Solution Comprising Hydroxypropyl Methylcellulose and Optionally Plasticizer:

To avoid lump formation X g hydroxypropyl methylcellulose was carefully and slowly filled into Y mL of stirred water in a beaker glass with screw cap (stirrer IKA RE166 with dissolver disk). After short time the powder was dissolved. The glass was closed with the screw cap and was put onto a roll for three hours. An overnight repose of the glass was used to regress the foam formation and potential air bubbles.

In a second step Z g of the plasticizer was filled into another beaker glass with screw cap. W g of the hydroxypropyl methylcellulose solution from the first step was added and the beaker glass was closed and was put onto a roll for three hours.

Examples 1-3 comprising HPMC AFFINISOL™ HME, Comparative Examples A-F comprising METHOCEL™ E3 LV and Comparative Examples G-H comprising METHOCEL™ K3 LV were prepared according to this general procedure.

### Examples 1-3 are Examples of the Present Invention

Comparative Examples A-F and G-H are prepared according to the procedure disclosed in PCT/US2021/014992

### Determination of Film Properties: Qualitative Optical and Qualitative Brittleness Determination

The solutions of Examples 1-3 and A-H were applied with a doctor blade having a slit width of 120 μm onto a glass plate and dried at 25° C. After drying, the film was optically inspected for cracks and surface defects both by direct visual inspection and by inspection under a microscope.

Coating of Paper with the Aqueous Solutions of Examples 1-3 and Comparative Examples A-H Followed by Heat-Sealing

In Examples 1-3, sheets of paper were coated with an aqueous solution comprising 40 g of AFFINISOL™ HME 15 and 160 g of water.

In Comparative Examples A-B sheets of paper were coated with an aqueous solution comprising 40 g of METHOCEL™ E3 LV and 160 g of water.

In Comparative Examples C-D sheets of paper were coated with an aqueous solution comprising 40 g of METHOCEL™ E3 LV, 10 g of propylene glycol, 10 g of ethyl lactate and 140 g of water.

In Comparative Examples E-F sheets of paper were coated with an aqueous solution comprising 40 g of METHOCEL™ E3 LV, 20 g of propylene glycol and 140 g of water.

In Comparative Examples G-H sheets of paper were coated with an aqueous solution comprising 40 g of METHOCEL™ K3 LV and 160 g of water.

Two coated papers were positioned between two heated stamps in such a way that both coated surfaces touched each other. Both heated stamps has a suface of 10 mm×10 mm and they were pressed together with a weight of about 1 kg, i.e. a pressure of 1 kg/cm².

The results appear from Table 1 below.

TABLE 1

| | Wet | | | | | | | | | | | | | |
|---|---|---|---|---|---|---|---|---|---|---|---|---|---|---|
| | film | Adhesion between both paper surfaces after sealing (at the | | | | | | | | | | | | |
| Example | thickness | mentioned temperature for 4 sec under load of 1 kg/cm², pull-off trial) | | | | | | | | | | | | |
| No. | (μm) | 120° C. | 130° C. | 140° C. | 150° C. | 160° C. | 170° C. | 180° C. | 190° C. | 200° C. | 210° C. | 220° C. | 230° C. | 240° C. |
| 1 | 100 | 1 | 1 | 1 | 2 | 4 | 4 | 4 | 4 | 4 | 4 | 4 | 4 | 4 |
| 2 | 200 | 1 | 1 | 1 | 4 | 2 | 4 | 4 | 4 | 4 | 4 | 4 | 4 | 4 |
| 3 | 200 | 1 | 1 | 1 | 2 | 2 | 4 | 4 | 4 | 4 | 4 | 4 | 4 | 4 |
| A | 100 | no | no | no | no | no | no | no | no | no | 2 | no | no | 2 |
| B | 200 | no | no | no | no | no | no | no | 3 | 3 | no | 2 | no | 2 |
| C | 100 | no | no | no | no | no | no | no | no | 3 | 2 | no | 2 | 3 |
| D | 200 | no | no | No | no | no | 3 | 3 | no | 3 | 3 | 2 | 2 | 3 |
| E | 100 | not | not | No | no | no | 3 | 3 | no | no | 2 | 2 | 2 | 3 |
| | | tested | tested | | | | | | | | | | | |
| F | 200 | not | not | No | no | no | 3 | 3 | 3 | 3 | 2 | 2 | 3 | 3 |
| | | tested | tested | | | | | | | | | | | |
| G | 100 | no | no | No | no | no | no | no | no | no | no | no | no | 1 |
| H | 200 | no | no | No | no | no | no | no | no | no | 3 | no | no | 1 |

| Symbol | Explanation |
|---|---|
| no | No adhesion. |
| 1 | Very little adhesion, not permanent. After pulling off the |
| | paper, both surfaces still look glossy. |
| 2 | Slightly more adhesion than 1, but still no permanent adhesion. |
| | After pulling off the paper, both surfaces still look glossy. |
| 3 | Permanent adhesion at a small part of the surface. After pulling |
| | off the paper, both surfaces show a little spot where paper fibers |
| | were pulled out of the surface and the coating was damaged. |
| 4 | Permanent adhesion at the full surface. After pulling off |
| | the paper, both surfaces show that paper fibers were pulled |
| | out of the surface and the coating was damaged. Inventive |

It appears from the results shown in Table 1 above that heat-sealed paper surfaces coated with the coating composition of Examples 1-3 show permanent adhesion (marked as “4”) when heat-sealed at temperatures from 170° C. to 240° C., while heat-sealed paper surfaces coated with the coating composition of Comparative Examples A-H show either no adhesion or no permanent adhesion over the entire surface (marked as “2” or “3”) at these temperatures. The results support the finding that a thermoplastic HPMC as described herein is suitable for providing a heat-sealable coating on paper or board, whereas non-thermoplastic HPMC grades are not suitable for this purpose.

1. An aqueous solution for forming a heat-sealable coating on a paper or board surface for reducing MOSH or MOAH migration, said aqueous solution comprising a thermoplastic hydroxypropyl methylcellulose (HPMC) in an amount of from 10% to 60% (w/w), wherein said HPMC has a DS(methyl) of at least 1.0 and an MS(hydroxypropyl) of at least 0.6, wherein DS is the average number of hydroxyl groups substituted by methoxyl groups per anhydroglucose unit and MS is the average number of moles of hydroxyalkoxy groups per anhydroglucose units, and wherein the viscosity of said HPMC is from 2 mPa·s to 100 mPa·s, determined as a 2% (w/w) solution in water at 20° C. according to Ubbelohde.

2. The aqueous solution according to claim 1, wherein the viscosity of the aqueous solution is from 200 to 80,000 mPa·s determined at 20° C. according to Haake.

3. The aqueous solution according to claim 1, comprising a plasticizer.

4. The aqueous solution according to claim 3, comprising a plasticizer in an amount of up to 30% (w/w).

5. The aqueous solution according to claim 3, wherein the plasticizer is selected from the group consisting of propylene glycol, ethyl lactate, glycerol and glycerol derivatives.

6. The aqueous solution according to claim 1, comprising water in an amount of from 30-90% (w/w).

7. A coating composition for forming a heat-sealable coating on a paper or board surface, said coating composition comprising the aqueous solution of claim 1.

8. A method of heat-sealing a portion or portions of a paper or board surface to reduce mineral oil saturated hydrocarbons (MOSH) or mineral oil aromatic hydrocarbons (MOAH) migration from the portion or portions of the surface, wherein the method comprises applying the coating of claim 7 to the portion or portions of the surface.

9. A paper or board surface comprising the heat-sealable coating composition according to claim 7, at least a portion of said surface being subjected to heat-sealing.

10. The paper or board surface of claim 9, wherein said portion of said surface is an edge or corner thereof.

11. The paper or board surface according to claim 9, wherein the paper or board is recycled paper or board or printed paper or board.

12. The paper or board surface according to claim 9, comprising a layer of the coating composition, which coating composition layer has a weight when dried of from 3 g/m² to 100 g/m².

13. The paper or board surface according to claim 1, which is pre-coated with a layer of non-thermoplastic HPMC before being coated with the heat-sealable coating composition of claim 7.

14. A method for heat-sealing at least a portion of a paper or board surface coated with the coating composition according to claim 7, the method comprising;
a. applying said coating composition on said paper or board surface,
b. drying the coating applied on said surface, and
c. heat-sealing at least a portion of said surface.

15. The method of claim 14, wherein the coating is applied in step a. with a doctor blade or by spraying, dispersion coating, curtain coating lamination or extrusion.

16. The method of claim 14, wherein the heat-sealing is conducted at a temperature of 150-250° C. and a load of 100 g/cm²-100 kg/cm².

17. The method of claim 14, wherein at least two edges of said coated paper or board surface are brought into alignment with one another and heat-sealed together at the edges.
